(19) United States
(12) Patent Application Publication
(10) Pub. No.: US 2010/0226623 A1
(43) Pub. Date: Sep. 9, 2010

(54) Time Setting in a Digital Television Processing Device

(75) Inventors: Steven Lee Cooper, Whitestown, IL (US); Mark Gilmore Mears, Zionsville, IN (US)

Correspondence Address: Robert D. Shedd, Patent Operations;THOMSON Licensing LLC, P.O. Box 5312, Princeton, NJ, 08543-5312, US

(73) Assignee: THOMSON LICENSING, Boulogne-billancourt (FR)

(21) Appl. No.: 12/223,142

(22) PCT Filed: Jan. 26, 2006
(86) PCT No.: PCT/US2006/003109

§ 371 Date: Jul. 23, 2008

(51) Int. Cl. H04N 5/91

(52) U.S. Cl. 386/83; 386/E05.003

(57) ABSTRACT

Setting of time in a digital television signal processing device is accomplished by identifying time data that matches or is closest to a user entered time. The identified television channel is then stored by the digital television signal processing device and used as a time source by the digital television channel processing device. The identification of a preferred time source (television channel) for the digital television signal processing device may be performed automatically once the user has manually inputted time information, or it may be performed through user interface such as through an on-screen display. Such identification may include a search of all available television channels having embedded time data.

### TECHNICAL FIELD

The present invention pertains to digital television devices and, more particularly, to the setting of time in a digital television device.

### BACKGROUND

A digital device such as a television or television signal processing device (e.g. a VCR, set top box, satellite processing device or the like) needs a source of time and, in some instances, a date in order to implement various time-related features or functions. An easy and first manner of setting time in a digital device was in like manner to the setting of a clock. The user manually inputted the time but with the aid of an on-screen display.

With the advent of the ability for a television channel to carry and thus provide time information along with audio/video information, television signal processing devices utilized the time information carried by a particular television channel. Typically, the television signal processing device allowed the user to manually set the time, but which was automatically overwritten when a television channel carrying such time information was located. In some instances, such prior art television signal processing devices skipped manual input and automatically set the time (clock) of the television signal processing device from the time information from a television channel.

While certain instances the above manner of setting the time in a television signal processing device may be acceptable, problems still exist. For example, several television channels can carry time and date information which can vary from channel to channel sometimes depending on the location of the television signal processing device relative to television broadcasters in different time zones for example. Another problem may occur in that the time and/or date information embedded in the television channel may just be completely wrong. In these instances, either the television signal processing device does not know which television channel's time information to use or utilizes time information from a television channel that is completely inaccurate.

It can therefore be appreciated from the above that there is a need to accurately set the time information in a television signal processing device that overcomes the above shortcomings.

### SUMMARY OF THE INVENTION

The present invention provides a manner of setting time in a digital television signal processing device. A television channel is identified that includes time data that with the least deviation from a user entered time. The identified television channel is then stored by the digital television signal processing device and used as a time source by the digital television channel processing device.

In one form, there is provided a method of operation of a digital television signal processing device. The method includes the steps of (a) receiving user input of time, (b) identifying a television channel having time data closest to the user inputted time, (c) storing the identified television channel, and (d) utilizing the stored identified television channel for a time source for the digital television signal processing device.

In another form, there is provided a television signal processing device. The television signal processing device includes a data entry device for receiving user input of time, a tuner, a controller, coupled to the tuner, for identifying a television channel having time data that is closest to the user inputted time, and memory, coupled to the controller, for storing the identified television channel, wherein the television signal processing device utilizes the stored identified television channel as a time source for time related features of the television signal processing device.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a block diagram of an exemplary digital television signal processing device that is operable in accordance with the present principles;

FIG. 2 is an illustration of an exemplary on-screen display of a user time and date set-up menu;

FIG. 3 is an illustration of an exemplary on-screen display of identified television channel selection for time use; and

FIG. 4 is a flowchart of an exemplary manner of operation of the exemplary digital television signal processing device of FIG. 1 in accordance with the present principles.

Corresponding reference characters indicate corresponding parts throughout the several views.

### DETAILED DESCRIPTION OF THE PREFERRED EMBODIMENT

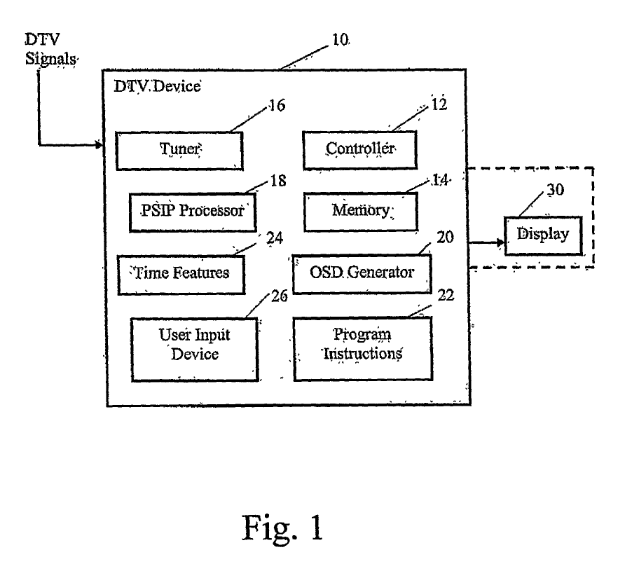

FIG. 1 depicts a block diagram of an exemplary digital television signal processing device or device, generally designated 10, that is operable in the manner described herein. The digital television signal processing device 10 is representative of various types of digital devices operable to receive, process and utilize digital television signals such as televisions, video recorders (e.g. VCRs, DVRs), set top boxes, satellite processing devices and the like. The digital television signal processing device 10 is also operable in typical manners for such digital devices although not specifically described herein.

The digital television signal processing device 10 includes a controller 12 that is configured, operable and/or adapted to provide control of the various components, modules or sections of the device in the manner described herein as well as those functions associated with such a digital television signal processing device 10 and not specifically described herein, and the processing of digital television signals such as is known in the art and as described herein. Memory 14 is provided that is in communication with the controller 12. The memory 14 stores data and provides the stored data as necessary to the various components as appropriate and under the control of the controller 12. Particularly, the controller 12 controls the reading and writing of information to and from the memory 14 as well as the dissemination of that data to the appropriate components per the present principles.

A digital television signal tuner 16 is provided that is operable, configured and/or adapted to tune digital television channels (signals) from input DTV signals (television channels). A PSIP (Program and System Information Protocol) processor 18 is provided that extracts various auxiliary data including time or time and date information from a tuned digital television channel.

Program instructions 22 are included that provide the necessary programming to allow the digital television signal processing device 10 to operate properly including in accordance with the present principles. The program instructions 22 may be stored in RAM, ROM or other memory or storage device. The program instructions 22 are utilized by the controller 12 to perform the functions described herein as well as the typical digital television signal processing device functions.

User input device 26 is also provided for allowing a user to input commands, menu selections and/or data as is appropriate and/or in accordance with the present principles. The user input device 26 may comprise a remote control, such as in infrared (IR) remote control, and a remote control processing device, such as an IR processing device. The user input device 26 may comprise or include, in addition to a remote control system, a keypad or other manner of allowing a user to input commands and/or data.

The device 20 further includes an on-screen display (OSD) generator 20. The OSD generator 20 is operable, configured and/or adapted to provide signals for the on-screen display of menus, text, data and/or the like. The digital television signal processing device 10 is shown connected to a display 30 for receipt and display of such on-screen generated menus, text and/or data as appropriate as well as for typical on-screen display. The display 30 by the dashed lines surrounding the display 30. The digital television signal processing device 10 also includes various time features 24 such as a clock and internal time features

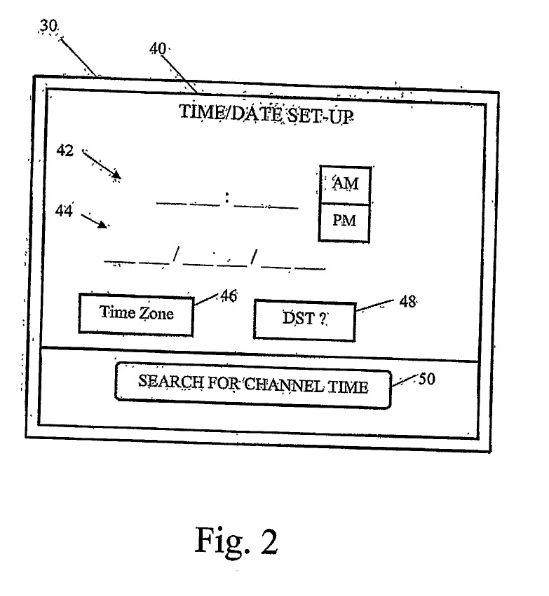

In accordance with the principles of the present invention, the digital television signal processing device 10 allows the user to set the time of day, e.g. the hour and minute, for use by the digital television signal processing device 10. Particularly, the digital television signal processing device 10 provides via the on-screen display generator 20 an on-screen time of day set-up menu such as the exemplary on-screen display of FIG. 2. Through the user input device 26, the user inputs the desired (current or local) time at input 42. AM and PM selection boxes may be provided in the typical case where time is entered with respect to a 12-hour clock rather than a 24-hours clock (which may alternatively be provided). A time zone selector 46 may be provided as well as a daylight savings time (DST) selector 48. Additionally, the user may input the date at input 44.

The manually entered time of day and date are stored in the memory 14. According to one implementation of the present principles, the time/date set-up screen 40 includes a “Search For Channel Time” (search) button or selection 50 (or provides such a search button as a query to the user after time/date input). When the user selects the search button 50, the digital television signal processing device conducts a search of available television channels (tunes the various available television channels) and processes the PSIP data to obtain time information (if available) for each tuned channel. The digital television signal processing device 10 compares the user entered time (and possibly date) with the time (and possibly date) information for each television channel. A television channel with the smallest deviation from the manually entered time of day (within an defined tolerance of, for example, plus or minus 10 minutes, or user selected) is identified. The digital television signal processing device 10 then either automatically uses the identified channel as the source for the time of day information or asks the user if the identified television channel should be used as the time source instead of the user-set time (since the former is updated continuously and is not free running and thus more reliable).

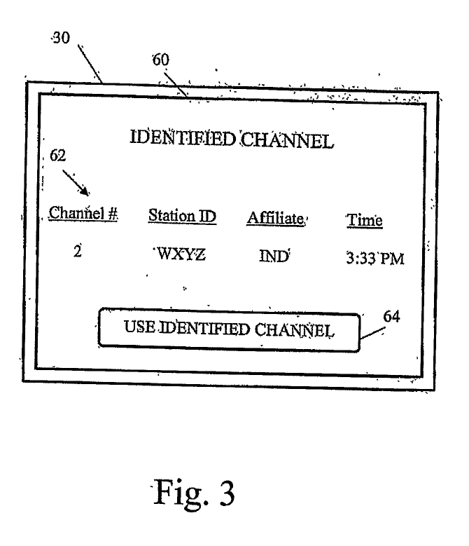

This may be accomplished by providing an on-screen display such as the exemplary on-screen display 60 depicted in FIG. 3. The on-screen display 60 provides an identification 62 of a television channel that includes time information that is the same or closest to the user-inputted time. In this example, the identification includes the channel number (#), station identification (ID or call letters), the station's affiliation and the time according to the time information for that channel. The on-screen display 60 also provides a selection 64 (“Use Identified Channel”) that asks (or prompts) the user whether or not the identified television channel should be used as the time source rather than the user-entered time. If the identified channel is selected, the digital television signal processing device 10 utilizes the identified channel as the time source, replacing the user-entered time. If the user decides not to use the selected channels, the digital television signal processing device may provide another television channel as the time source or just use the user-entered time as the time source. More than one television channel may be presented for the user to choose as the time source should more than one television channel fall within the time tolerance.

Alternatively, the search for a reliable time source television channel is conducted at a later time (e.g. when the television is off or in standby mode, or during the normal course of changing channels while using the television rather than providing a separate search) and then presenting the result(s) to the user when the television was turned back on or if the user went back into the time/date entry screen. At this time then, the user would be asked if he would like to use the identified channel as the trusted time source.

This operation, according to one implementation, may be conducted automatically once the time (or time and date) information has been manually entered by the user.

The present invention provides a method to identify and store a channel that is transmitting the time or time and date that is closest to the actual time or time and date. The result is that the digital television signal processing device uses consistent (and correct) time and date information from channel to channel (i.e. regardless of the time information that may be provided in each channel's auxiliary data portion).

Various alternative manners of allowing the user to select a television channel whose time information is to be the time source may be utilized. For example, after user entry of time, the digital television signal processing device may display a menu having a list or listing or all receivable (tunable) channels and their associated time (after the television signal processing device tuned all channels and sampled their time/date data). The menu would allow the user to select which channel's time/date data to use as the valid time source (store the channel that is the selected valid time source.

Another manner is to allow the digital television signal processing device to automatically select the channel with the correct time/date information. Thus, instead of asking the user to select a particular channel which has been identified to have a similar time as the user has already set up, the digital television processing device would, over the course of normal channel tuning by the user or automatically right after time/date set up, automatically identify and save a channel with time/date data similar or the same to the user-set time/date. This relieves the user the necessity of selecting the channel as the time source. The digital television signal processing device may include the ability for the user to override the automatic selection and manually provide (or via the search feature) to select a channel. The digital television signal processing device may also include an override to disable the television's automatic channel selection.

Additionally, the digital television signal processing device is operable, upon start-up of the digital television signal processing device from a standby mode (or off) unbeknownst to the user, to tune very briefly to the stored, identified time source television channel to acquire the proper time for use by the various time features. After tuning to the trusted time source channel, the digital television signal processing device may tune to the last channel that it was tuned to prior to being turned off. This may be especially useful in the situation where there is a loss of power.

Moreover, if the digital television signal processing device is connected to the Internet (such as enabled with a modem or Ethernet broadband connection for example) time may be set via the Internet.

It should be appreciated that while the present invention is described with respect to digital television processing devices/signals, it should be appreciated that the present invention applies equally to analog television processing devices/signals.

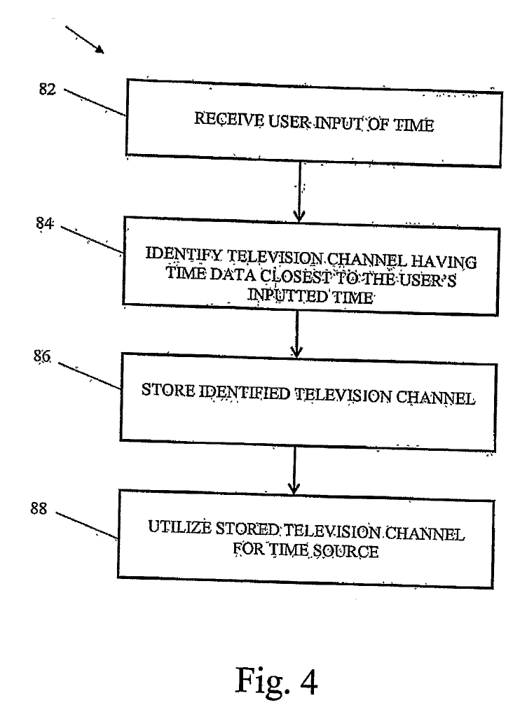

Referring to FIG. 4, there is depicted a flowchart 80 of an exemplary manner of operation of a digital television signal processing device according to the principles presented herein. It should be appreciated that the manner of operation depicted by the flowchart 80 is a simplified manner of operation and that additional steps or less steps may be used or required to implement the present invention or the entire features described herein.

In step or box 82, the digital television signal processing device receives time inputted by the user (i.e. manual input of time). In step or box 84, a television channel having time data that is closest (matches or is within a predetermined tolerance thereof) to the user's inputted time is identified. In step or box 86, the identified television channel is then stored. Thereafter, in step or box 88, the identified television channel is utilized for the time source by the digital television signal processing device.

While this invention has been described as having a preferred design, the present invention can be further modified within the spirit and scope of this disclosure. This application is therefore intended to cover any variations, uses, of adaptations of the invention using its general principles. Further, this application is intended to cover such departures from the present disclosure as come within known or customary practice in the art to which this invention pertains and that fall within the limits of the appended claims.

1. A method of operation of a television signal processing device, the method comprising the steps of:
receiving input of data representing a first time of day;
selecting a television channel comprising data representing a first time of day having a predefined relationship to the first time of day;
utilizing the selected television channel as a time source for the television signal processing device.

2. The method of claim 1, wherein the step of selecting a television channel is performed automatically.

3. The method of claim 1, wherein the step of selecting a television channel is performed through user interface.

4. The method of claim 1, wherein the step of selecting a television channel comprises:
searching all available television channels to locate television channels having embedded time data; and
comparing time data of each of the located television channels having embedded time data to the received input of data representing a first time of day.

5. The method of claim 4, wherein the step of identifying a television channel further comprises the step of:
facilitating user selection of the television channel having embedded time data.

6. The method of claim 1, wherein the step of identifying a television channel comprises:
searching all available digital television channels having embedded time data; and
comparing time data of each of the located digital television channels having embedded time data to the received input of data representing a first time of day.

7. A digital television signal processing device comprising:
a data entry device for receiving user input of time of day;
a digital tuner for locating digital television channels comprising time of day data;
a controller, coupled to the digital tuner, for selecting a located digital television channel having time of day data according to a predefined relationship to the user input time of day; and
the digital television signal processing device utilizing the selected digital television channel as a time of day source for time of day related features of the digital television signal processing device.

8. The digital television signal processing device of claim 7, wherein the controller automatically selects a located digital television channel having time data with the least time deviance to the user input time of day.

9. The digital television signal processing device of claim 7, further 25, comprising an on-screen display generator, coupled to the controller, for displaying a digital television channel having time of day data with the least time deviance to the user input time of day, and for providing a user selection for permitting use of the digital television channel as the time source.

10. The digital television signal processing device of claim 7, wherein the controller selects a digital television channel having time of day data with the least time deviance to the user input time of day by:
causing the tuner to tune all available digital television channels; and
comparing time of day data of digital television channels comprising embedded time of day data to the user inputted time.

11. A television signal processing device comprising:
means for receiving user input of time of day;
means for tuning television channels having embedded time of day data;
means, coupled to the means for tuning, for selecting a tuned television channel having embedded time of day data having the least deviation from the user input time of day; and
wherein the television signal processing device utilizes the selected television channel as a time of day source for time of day related features of the television signal processing device.

12. The television signal processing device of claim 11, wherein the tuned television channels correspond to digital television signals.

13. The television signal processing device of claim 11, wherein tuned television channels correspond to analog television signals.

14. The television signal processing device of claim 11, wherein the means for selecting a tuned television channel having time of day data having the least deviation from the user input time of day automatically identifies a television channel having time of day data having the least deviation from the user input time of day.

15. The television signal processing device of claim 11, wherein the means for selecting a television channel having time of day data having the least deviation from the user input time of day is operable to cause the means for tuning to tune all available television channels having embedded time of day data, and to compare time data of located television channels having embedded time data to the user inputted time.

16. The television signal of claim 11, further comprising means, coupled to the means for selecting, for providing on-screen display of the selected television channel having time of day data, and for providing a user selection for authorizing use of the selected television channel as the time source.
